(19) United States
(12) Patent Application Publication
(10) Pub. No.: US 2013/0234989 A1
(43) Pub. Date: Sep. 12, 2013

(54) TOUCH PANEL WITH DISCHARGING FUNCTION

(71) Applicant: SITRONIX TECHNOLOGY CORP., HSINCHU COUNTY (TW)

(72) Inventors: CHIH-DE HUNG, HSINCHU COUNTY (TW); CHENG-CHUNG YEH, HSINCHU COUNTY (TW); TING-LONG KUO, HSINCHU COUNTY (TW)

(73) Assignee: SITRONIX TECHNOLOGY CORP., HSINCHU COUNTY (TW)

(21) Appl. No.: 13/872,395

(22) Filed: Apr. 29, 2013

Related U.S. Application Data
(62) Division of application No. 12/817,521, filed on Jun. 17, 2010.

(51) Int. Cl. G06F 3/044

(52) U.S. Cl. CPC G06F 3/044
USPC 345/174

(57) ABSTRACT

The present invention relates to a touch panel with a discharging function, which comprises a scanning bus, a sensing bus, a control unit, and a discharging circuit. The scanning bus is used for scanning a touch frame. The sensing bus interleaves with the scanning bus, and senses at least a touched location on the touch frame. The control unit is coupled to the scanning bus and the sensing bus 20′ for controlling them. The discharging circuit is coupled to the sensing bus or/and the scanning bus, and is controlled by the control unit for releasing the charges at the touched location or/and on the relevant path between the touched location and the buses. Thereby, by using a discharging circuit for releasing charges on the parasitic capacitor, the parasitic capacitance effect is avoided. Hence, the sensing accuracy of the touch panel is increased.

### REFERENCE TO RELATED APPLICATION

This Patent Application is being filed as a Divisional application of Ser. No. 12/817,521, filed on 17 Jun. 2010, currently pending.

### FIELD OF THE INVENTION

The present invention relates generally to a touch panel, and particularly to a touch panel with a discharging function.

### BACKGROUND OF THE INVENTION

Recently, various electronic products are developed in the trend of easier operations, small volume, and large displays. In particular, portable electronic products are demanding severely in volume and display size. Thereby, many electronic products integrate touch panels and liquid-crystal displays for saving the space required by keyboards or operational keys, and hence expanding the area available for displays.

Currently, touch panels can be categorized into resistive, capacitive, infrared, and ultrasonic touch panels, and the resistive and capacitive panels are most popular. For capacitive touch panels, the feature of multi-point control provides more friendly operation modes, and thus is gradually favorable in the market. However, capacitive touch panels can only be operated by touching the panel with conductive materials. Thereby, users cannot operate them in gloves or using nonconductive materials.

On the other hand, resistive touch panels are operable no matter what material is used by a user to touch the touch panels, and hence enhancing their convenience. Besides, their costs are relatively lower, and their technologies are developed more maturely. Thereby, their market share is higher.

FIG. 1 shows a structural schematic diagram of a touch panel according to the prior art. As shown in the figure, the touch panel comprises a scanning bus 10′, a sensing bus 20′, and a control unit 30′. The scanning bus 10′ is used for scanning a touch frame. The sensing bus 20′ interleaves with the scanning bus 10′, and senses at least a touched location on the touch frame. The control unit 30′ is coupled to the scanning bus 10′ and the sensing bus 20′ for controlling them and knowing that at least a location on the touch frame is touched. No matter for capacitive or resistive touch panels, particularly for multi-point applications, the grid structure is generally used for achieving the multi-point effect. The sensing parts at the grids are formed by transparent conductive films. Hence, there exist parasitic capacitance effects at the locations where two layers of transparent conductive films overlap. Thereby, at the scanning transient, the signal on the scanning bus 10′ will interfere the signal on the sensing bus 20′ owing to the coupling effect between the parasitic capacitors in the touch panel. Consequently, when the system measures, erroneous judgment for the signals occurs, reducing drastically the accuracy.

Accordingly, the present invention provides a novel touch panel with a discharging function, which can avoid the parasitic capacitance effect, which results in erroneous judgment for signals. Hence, the accuracy is increased significantly, and the problem described is solved.

### SUMMARY

An objective of the present invention is to provide a touch with a discharging function, which uses a discharging circuit for releasing charges on the parasitic capacitor and avoiding parasitic capacitance effect. Hence, the sensing accuracy of the touch panel is increased.

The touch panel with a discharging function according to the present invention comprises a scanning bus, a sensing bus, a control unit, and a discharging circuit. The scanning bus is used for scanning a touch frame. The sensing bus interleaves with the scanning bus, and senses at least a touched location on the touch frame. The control unit is coupled to the scanning bus and the sensing bus 20′ for controlling them. The discharging circuit is coupled to the sensing bus or/and the scanning bus, and is controlled by the control unit for releasing the charges at the touched location or/and on the relevant path between the touched location and the buses. Thereby, by using a discharging circuit for releasing charges on the parasitic capacitor, the parasitic capacitance effect is avoided. Hence, the sensing accuracy of the touch panel is increased.

### BRIEF DESCRIPTION OF THE DRAWINGS

FIG. 1 shows a structural schematic diagram of a touch panel according to the prior art;

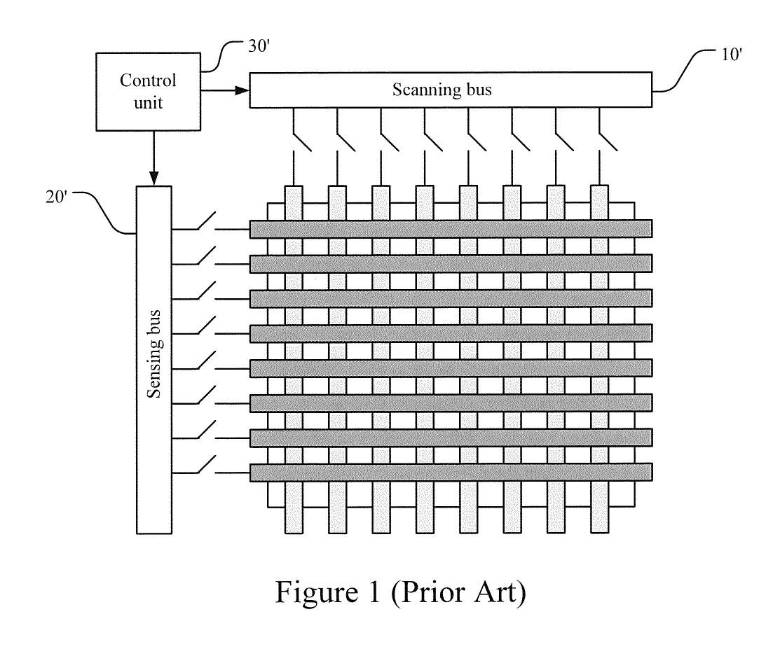

FIG. 2 shows a structural schematic diagram according to a preferred embodiment of the present invention;

FIG. 3 shows a structural schematic diagram according to another preferred embodiment of the present invention;

FIG. 4 shows a structural schematic diagram according to another preferred embodiment of the present invention;

FIG. 5 shows a structural schematic diagram according to another preferred embodiment of the present invention;

FIG. 6 shows a structural schematic diagram according to another preferred embodiment of the present invention;

FIG. 7 shows a discharge timing diagram according to a preferred embodiment of the present invention;

FIG. 8A shows a schematic diagram of discharging according to a preferred embodiment of the present invention;

FIG. 8B shows a schematic diagram of discharging according to a preferred embodiment of the present invention;

FIG. 8C shows a schematic diagram of discharging according to a preferred embodiment of the present invention; and

FIG. 9 shows a structural schematic diagram according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

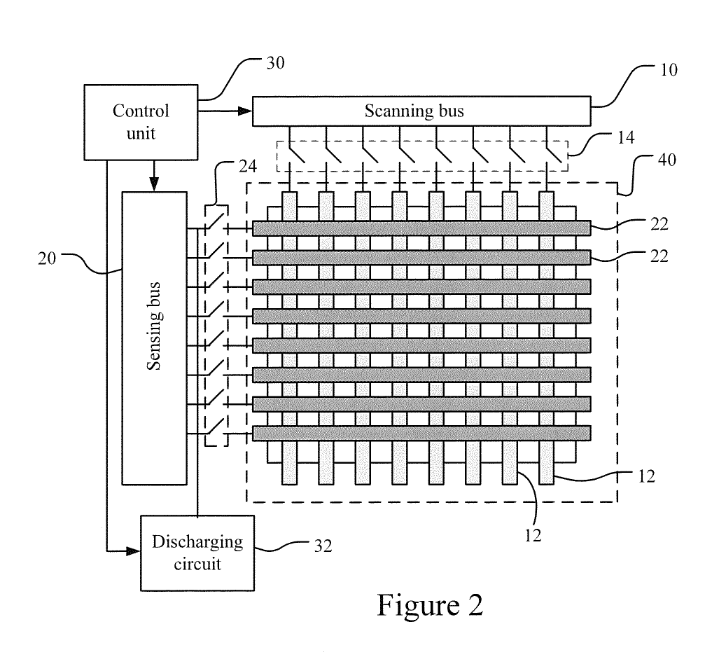

FIG. 2 shows a structural schematic diagram according to a preferred embodiment of the present invention. As shown in the Figure, the touch panel with a discharging function according to the present invention comprises a scanning bus 10, a sensing bus 20, a control unit 30, and a discharging circuit 32. The scanning bus 10 is used for scanning a touch frame 40. The sensing bus 20 interleaves with the scanning bus 10, and senses at least a touched location on the touch frame 40. Namely, the scanning bus 10 is coupled to a plurality of scanning lines 12; the sensing bus 20 is coupled to a plurality of sensing lines 22. The plurality of scanning lines 12 of the scanning bus 10 interleave with the plurality of sensing lines 22 of the sensing bus 20. The plurality of scanning lines 12 and the plurality of sensing lines 22 are located in different layers. Between the plurality of scanning lines 12 and the plurality of sensing lines 22, nonconductive objects such as spacers, glass, or films are used for isolating the layers of the lines (not shown in the Figure) and forming the touch frame 40. The above-mentioned technique is common for persons having ordinary skill in the art, and hence will not be described further in detail. The plurality of scanning lines 12 and the plurality of sensing lines 22 are formed on conductive films. A preferred embodiment of the conductive film is a transparent conductive oxide (TCO) film. According to the present invention, the grid structure of touch panel is adopted for achieving the multi-point touch effect. However, this is only a preferred embodiment of the present invention. The present invention is not limited to the structure of touch panel. Those touch panels formed by conductive films are within the scope of the present invention.

The control unit 30 is coupled to the scanning bus 10 and the sensing bus 20 for controlling them. A plurality of switches 14 are disposed between the scanning bus 10 and the plurality of scanning lines 12, respectively. The control unit 30 controls the plurality of switches 14, and hence controlling the scanning bus 10 to scan the touch frame 40 via the plurality scanning lines 12. Likewise, a plurality of switches 24 are disposed between the sensing bus 20 and the plurality of sensing lines 22, respectively. The control unit 30 controls the plurality of switches 24, and hence controlling the sensing bus 20 to sense if the touch frame 40 is touches. When the touch frame 40 is touched, the scanning bus 10 and the sensing bus 20 will produce at least a scanning signal and at least a sensing signal, respectively, according to the touched location on the touch frame 40, and transmit the scanning signal and the sensing signal to the control unit 30, respectively. The control unit 30 then calculates to give the coordinate of the touched location according to the scanning signal and the sensing signal.

Because some portions of the plurality of scanning lines 12 coupled to the scanning bus 10 cross with some portions of the plurality of sensing lines 22 coupled to the sensing bus 20, the parasitic capacitance effect occur at the locations where the conductive films cross each other. Alternatively, some residual charges remains on the scanning lines 12 and the sensing lines 22. During the using process of the touch frame 40 of the touch panel, after many touches, it is easy to increase the charges on the touch panel and thereby affecting the overall performance. In some circumstances, the signal will be produced even the touch panel is not touched, leading to false judgment. In other words, at the scanning transient, the signal on the scanning bus 10 may interfere the signal on the sensing bus 20 owing to the coupling effect between parasitic capacitors in the touch panel. Consequently, when the system measures, erroneous judgment for the signals occurs, reducing drastically the accuracy.

Accordingly, the touch panel according to the present invention uses the discharging circuit 32 coupled to the sensing bus 20 and controlled by the control unit 30 for releasing the charges at the touched location on the touch frame 40. Thereby, after many touches during the using process of the touch panel, the charges accumulated on the touch panel can be avoided, and hence increasing the overall performance and preventing erroneous judgment for the untouched condition.

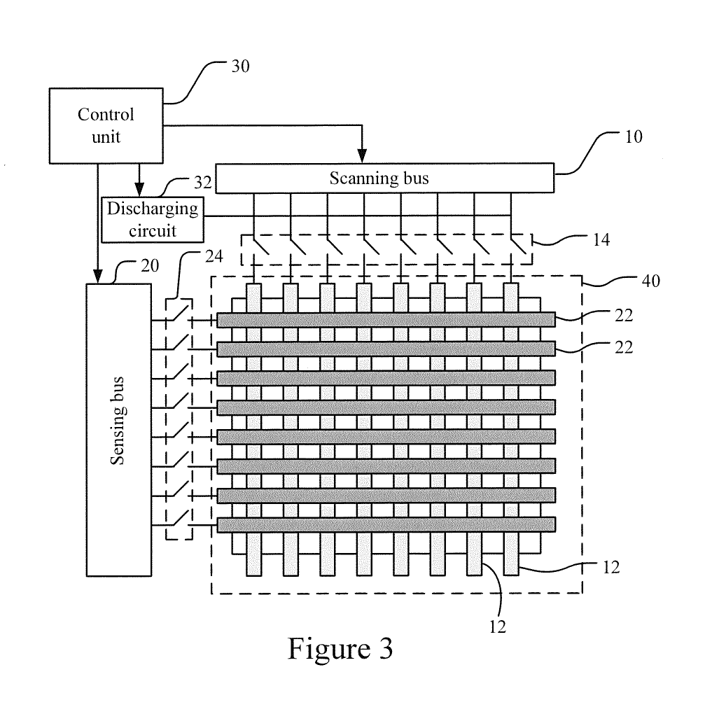

FIG. 3 shows a structural schematic diagram according to another preferred embodiment of the present invention. As shown in the figure, the difference between the present embodiment and the one in FIG. 2 is that the discharging circuit 32 according to the present embodiment is disposed between the scanning bus 10 and the scanning lines 12, and is controlled by the control unit 30 for releasing the charges at the touched location of the touch frame 40. Thereby, the charges accumulated on the touch panel are reduced, and hence increasing the overall performance and preventing erroneous judgment for the untouched condition.

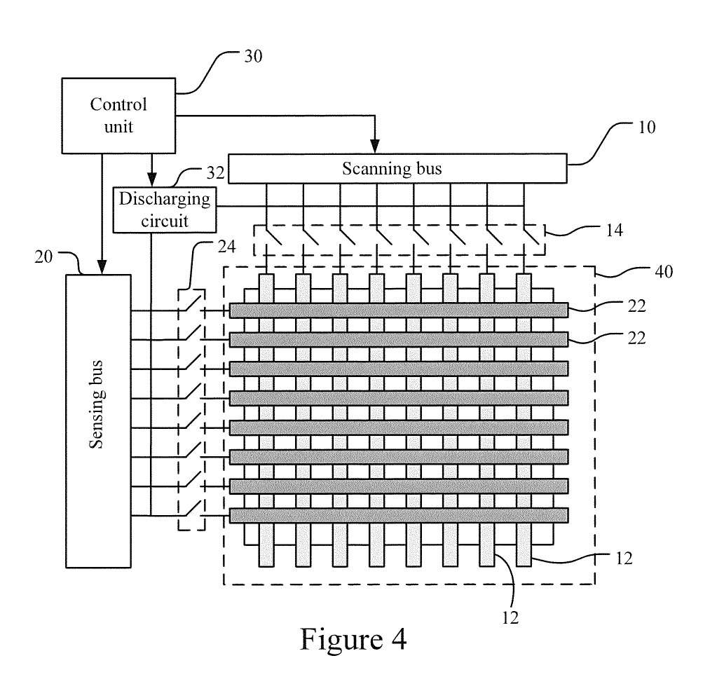

FIG. 4 shows a structural schematic diagram according to another preferred embodiment of the present invention. As shown in the figure, the difference between the present embodiment and those described above is that the discharging circuit 32 according to the present embodiment is disposed on the scanning bus 10 as well as the sensing bus 20 for enhancing charge releasing effect and hence increasing the sensing accuracy of the touch panel. Because the discharging circuit 32 according to the present embodiment is the same as those described above, its details will not be described further.

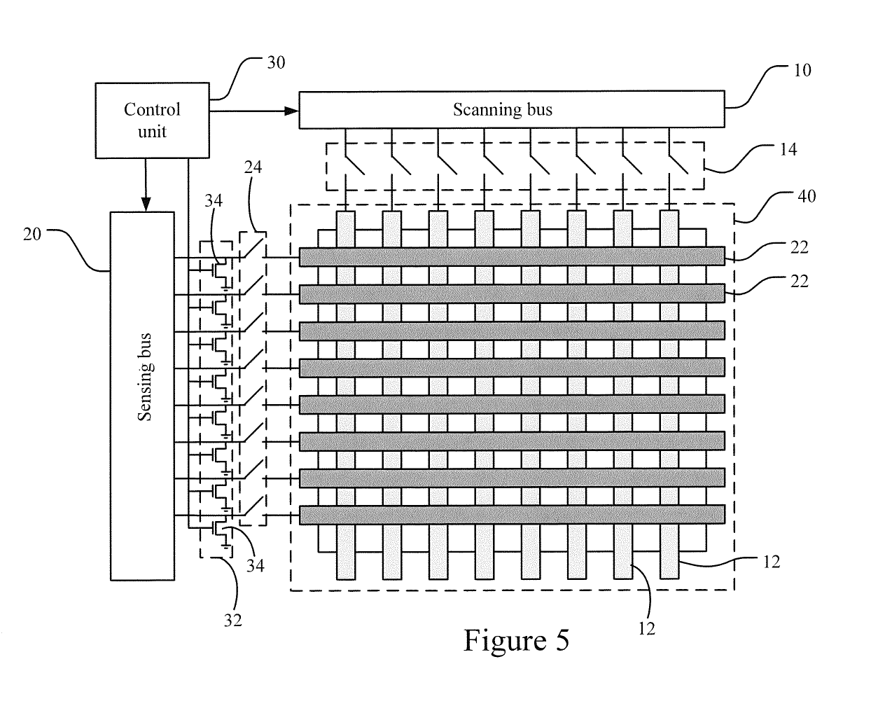

FIG. 5 shows a structural schematic diagram according to another preferred embodiment of the present invention. As shown in the figure, the difference between the present embodiment and the one in FIG. 2 is that the discharging circuit 32 according to the present embodiment comprises a plurality of discharging switches 34 disposed between the sensing bus 20 and the sensing lines 22, respectively. When the control unit 30 produces the discharging signal to the plurality of discharging switches 34, the plurality of discharging switches 34 are closed for releasing the charges accumulated at the touched location on the touch frame 40. The discharging switch 34 can be a field-effect transistor or a bipolar junction transistor (BJT). However, using a field-effect transistor or a BJT as the discharging switch 34 is only a preferred embodiment, not used for limiting the scope of the present invention.

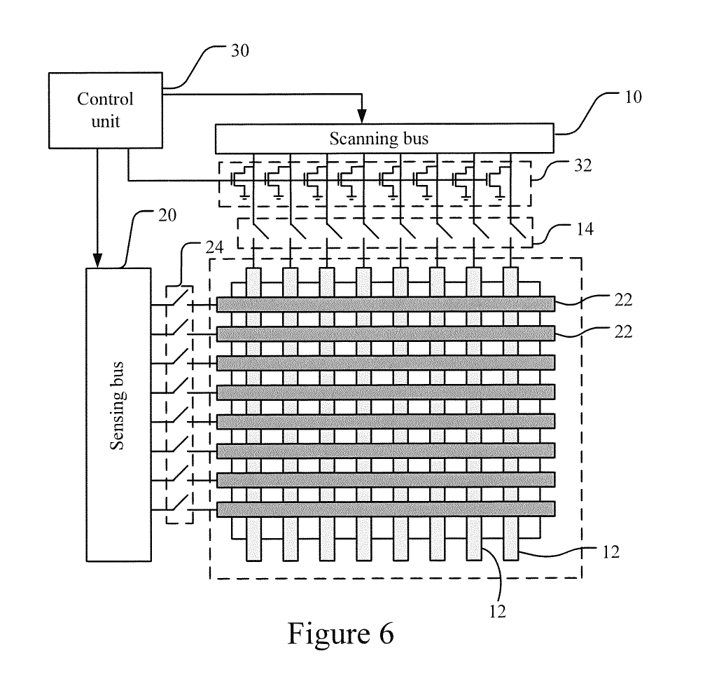

FIG. 6 shows a structural schematic diagram according to another preferred embodiment of the present invention. As shown in the figure, the difference between the present embodiment and the one in FIG. 5 is that the plurality of discharging switches of the discharging circuit 32 according to the present embodiment are disposed between the scanning bus 10 and scanning lines 12 for releasing the charges accumulated at the touched location on the touch frame 40.

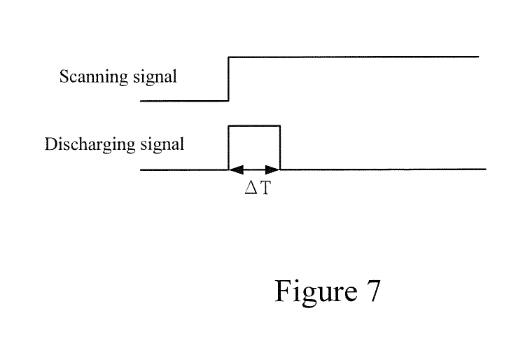

FIG. 7 shows a discharge timing diagram according to a preferred embodiment of the present invention. As shown in the figure, the control unit 30 according to the present invention controls the sensing lines 22 of the sensing bus 20 to discharge (as shown in FIG. 2) while the scanning bus 10 is scanning and hence releasing the charges on the touch frame 40. Alternatively, the control unit 30 controls the discharging circuit 32 to discharge the scanning lines 12 of the scanning bus 10. The control unit 30 also can control the discharging circuit 32 to discharge the scanning lines of the scanning bus 10 and the sensing lines 22 of the scanning bus 20 simultaneously. The control unit 30 discharges the touch frame 40 according to a discharge timing and hence releasing the charges accumulated at the touched location or/and relevant circuits between the touched location and the buses. In other words, the control circuit 30 drives the scanning bus 10 to produce a scanning signal. Then, the control circuit 30 produces and transmits a discharging signal to the discharging circuit 32 for discharging the sensing bus 20 or discharging the rest un-scanned scanning lines. In addition, the control unit can adjust the discharge timing for controlling the time for releasing the residual charges on the touch frame 40. Namely, the control circuit 30 can control a discharging time AT of the discharging circuit 32 and determine the discharging time for the touch frame 40. Thereby, the parasitic capacitance effect can be avoided, and thus increasing the sensing accuracy of the touch panel.

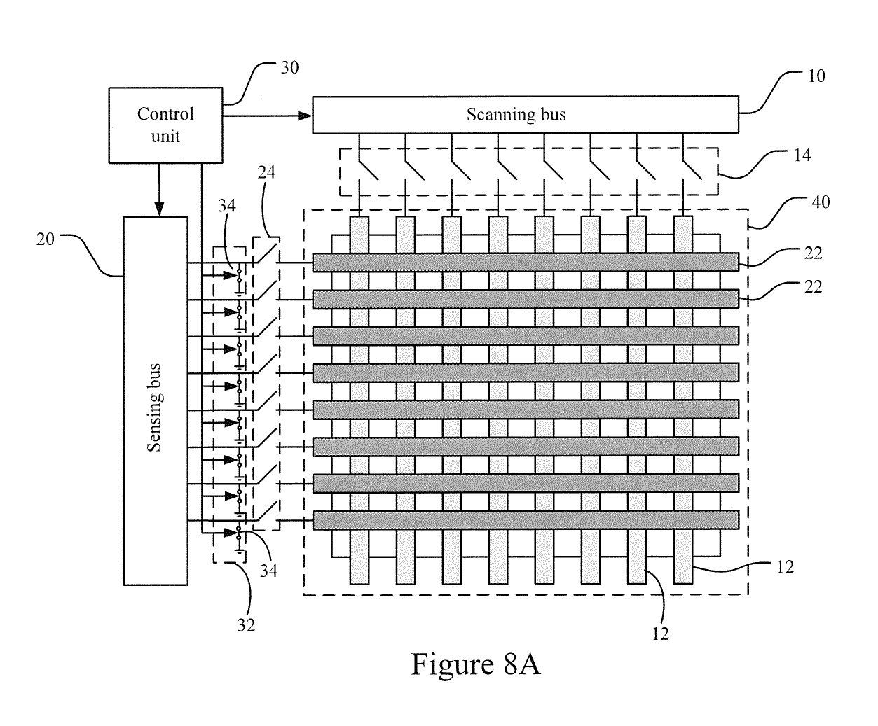

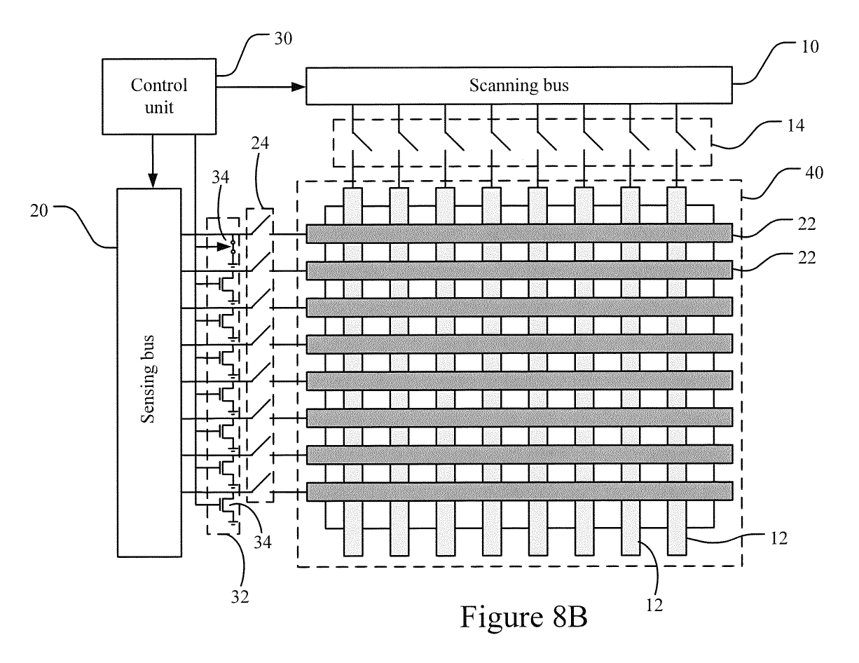

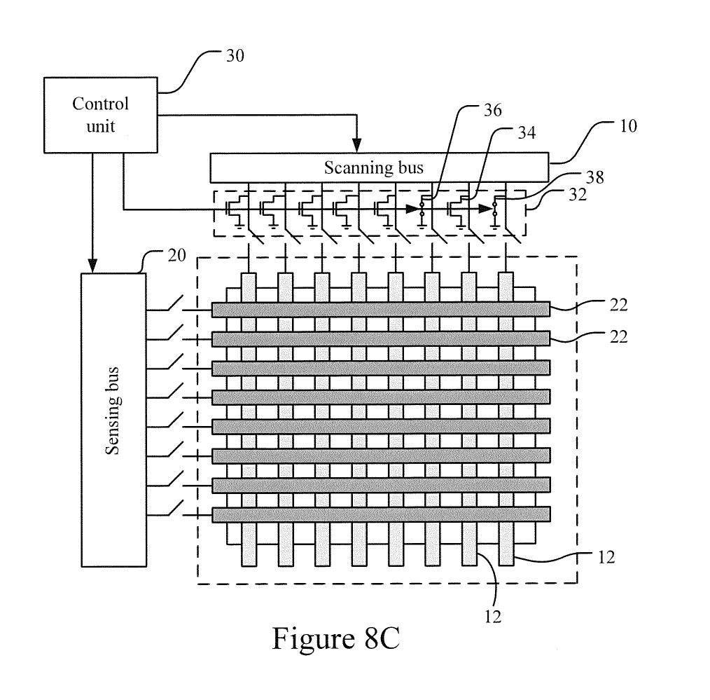

Besides, the timing by which the control unit 30 controls the discharging circuit 32 described above is only a preferred embodiment, not used for limiting the present invention. In the following, various discharge timing by which the control unit 30 controls the discharging circuit 32 is described. First, also refer to FIG. 8A, which shows a schematic diagram of discharging according to a preferred embodiment of the present invention. As shown in the figure, before the control unit 30 controls the scanning bus 10 to scan the touch frame 40, the control unit 30 controls the discharging circuit 32 of the sensing bus 20 to release the charges at the touched location and on the relevant path between the touched location and the buses. In other words, when the control unit 30 is to sense if the touch frame 40 is touched, before the control unit 30 controls the scanning bus 10 to scan, the control unit 30 controls the discharging circuit 32 to release charges on the touch frame 40, which is accomplished by closing the plurality of discharging switches 34 and hence releasing the charges on the touch frame 40. Similarly, after the control unit 30 scans the touch frame 40, the control unit 30 controls the discharging circuit 32 of the sensing bus 20 to release the charges at the touched location and on the relevant path between the touched location and the buses.

In addition, when the discharging circuit 32 is disposed on the scanning bus 10 (not shown in the figure), before and after the control unit 30 scans the touch frame 40, the control unit 30 controls the discharging circuit 32 of the scanning bus 10 to release the charges at the touched location and on the relevant path between the touched location and the buses. This discharging method is the same as the one described above, and hence will not be described any further.

Moreover, before or after sensing bus 20 senses the touched location, the control unit 30 can control the discharging circuit 32 of the scanning bus 10 to release the charges at the touched location and on the relevant path between the touched location and the buses on the touch frame 40 for avoiding accumulation of residual charges. Besides, after the scanning bus 10 or the sensing bus 20 completes a scanning cycle, the control unit 30 can control the discharging circuit 32 of the scanning bus 10 to release the charges at the touched location and on the relevant path between the touched location and the buses on the touch frame 40 for avoiding accumulation of residual charges at the touched location and on the plurality of scanning lines 12 or on the plurality of sensing lines 22.

FIG. 8B shows a schematic diagram of discharging according to a preferred embodiment of the present invention. As shown in the figure, the difference between the present preferred embodiment and the one in FIG. 8A is that according to the present preferred embodiment, each sensing line 22 of the sensing bus 20 releases the charges at the touched location on the touch frame 40 and on the path of the sensing line 22. The discharge timing according to the present preferred embodiment is the same the one in FIG. 8A, and hence will not be described again.

FIG. 8C shows a schematic diagram of discharging according to a preferred embodiment of the present invention. As shown in the figure, the difference between the present preferred embodiment and previous one is that, according to the present preferred embodiment, when the scanning bus 10 scans the touch frame 40 the control unit 30 controls the discharging circuit 32 to release charges on the un-scanned scanning lines 12 of the scanning bus 10. Namely, when the scanning bus 10 scans the second scanning line 34 of the touch frame 40, the control unit 30 can close the discharging switches 36, 38 on adjacent scanning lines and release charges. Thereby, the parasitic capacitance effect can be avoided, and the sensing accuracy of the touch panel can be enhanced. Besides, the control unit 30 also can control the discharging circuit 32 to release the charges on the plurality of scanning lines 12 being scanned by the scanning bus 10. In other words, when the scanning bus 10 scans the second scanning line 34 of the touch frame 40, the control unit 30 can release the charges on the second scanning line 34 at the same time. Likewise, when the scanning bus 10 scans the touch frame 40, the control unit 30 can control the discharging circuit 32 to release the charges on the un-sensed sensing lines 22 of the sensing bus 20 (not shown in the figure). Moreover, when the scanning bus 10 scans the touch frame 40, the control unit 30 can control the discharging circuit 32 to release the charges on the plurality of sensing lines 22 being sensed by the sensing bus 20. Because the drawing of this embodiment is easily figured out by persons having ordinary skill in the art, it will not be drawn again.

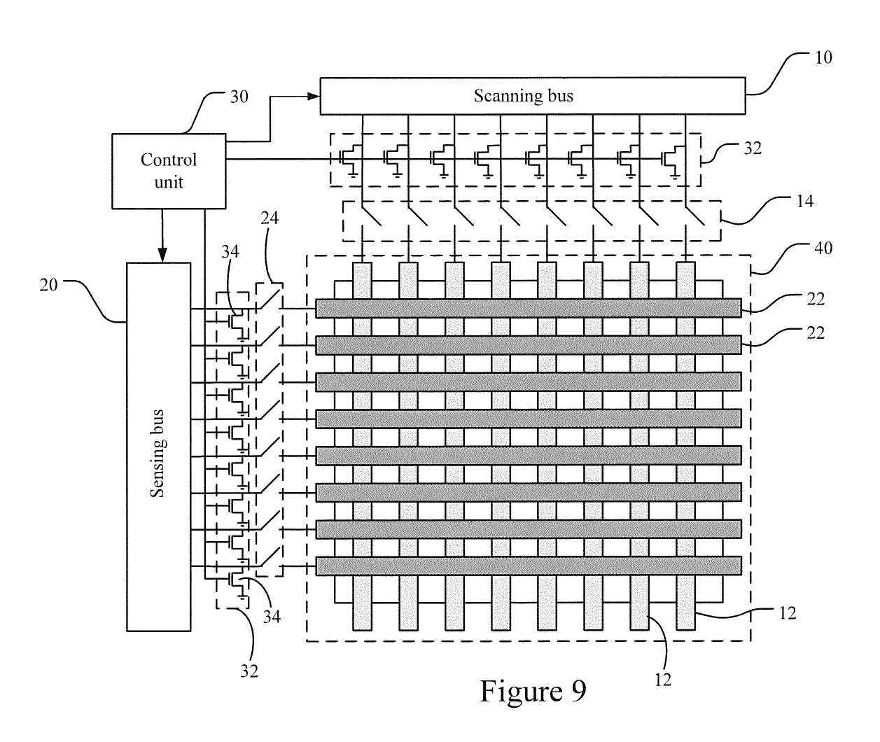

FIG. 9 shows a structural schematic diagram according to another preferred embodiment of the present invention. As shown in the figure, the difference between the present preferred embodiment and the previous one is hat the discharging circuit 32 according to the present preferred embodiment is disposed on both the scanning bus 10 and the sensing bus 20 for increasing charge-releasing effect, and hence enhancing sensing accuracy of the touch panel. Because the discharging circuit 32 according to the present preferred embodiment is the same as the one in the previous preferred embodiment, it is not described in more detail.

To sum up, the touch panel with a discharging function according to the present invention comprises a scanning bus, a sensing bus, a control unit, and a discharging circuit. The scanning bus is used for scanning a touch frame. The sensing bus interleaves with the scanning bus, and senses at least a touched location on the touch frame. The control unit is coupled to the scanning bus and the sensing bus 20′ for controlling them. The discharging circuit is coupled to the sensing bus or/and the scanning bus, and is controlled by the control unit for releasing the charges at the touched location or/and on the relevant path between the touched location and the buses. Thereby, by using a discharging circuit for releasing charges on the parasitic capacitor, the parasitic capacitance effect is avoided. Hence, the sensing accuracy of the touch panel is increased.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A touch panel with a discharging function, comprising:
a scanning bus, coupled to a plurality of scanning lines, and used for scanning a touch frame;
a sensing bus, coupled to a plurality of sensing lines, said plurality of sensing lines interleaving with said plurality of scanning lines, respectively, and said plurality of sensing lines sensing at least a touched location on said touch frame;
a control unit, coupled to said scanning bus and said sensing bus for controlling said scanning bus and said sensing bus; and a discharging circuit, coupled to said sensing bus or/and said scanning bus, and controlled by said control unit for releasing the charges at said touched location;
wherein after said sensing bus senses said touched location, said control unit controls said discharging circuit to release the charges at said touched location or/and on the relevant path between said touched location and said scanning bus or/and said sensing bus.

2. The touch panel with a discharging function of claim 1, wherein said control unit controls said discharging circuit to release the charges at said touched location or/and on the relevant path between said touched location and said scanning bus or/and said sensing bus according to a discharge timing.

3. The touch panel with a discharging function of claim 2, wherein said control unit can adjust the timing of discharge for controlling the time said discharging circuit discharges.

4. The touch panel with a discharging function of claim 1, wherein said discharging circuit includes a switch.

5. The touch panel with a discharging function of claim 4, wherein said switch is a field-effect transistor or a bipolar junction transistor.

6. The touch panel with a discharging function of claim 1, wherein said plurality of scanning lines and said plurality of sensing lines are conductive films

7. The touch panel with a discharging function of claim 6, wherein said conductive film is a transparent conductive oxide film.
